(19) United States
(12) Patent Application Publication
(10) Pub. No.: US 2006/0249090 A1
(43) Pub. Date: Nov. 9, 2006

(54) Pet toilets

(76) Inventor: George A. Ahad, Highland Park, MI (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/121,968

(22) Filed: May 5, 2005

(51) Int. Cl. A01K 1/035

(52) U.S. Cl. 119/163

(57) ABSTRACT

In view of the aforementioned considerations, a pet toilet comprises a stooling floor for receiving thereon animal waste in the form of feces and urine, the stooling floor having first and second ends. A trough is provided at the second end of the stooling floor for receiving waste from the stooling floor, the trough being connected to a sewer system for disposal of the waste. A squeegee is provided having at least one blade with a first edge in contact with the stooling floor. The blade extends across the stooling floor and is movable from the first end to the second end of the stooling floor to move the waste into the trough. A fluid dispenser for dispensing liquid onto the stooling floor facilitates removal of the waste and washes the floor. The squeegee is advanced from the first end to the second end of the stooling floor to move the waste and liquid toward and into the trough. In a further aspect of the invention, the toilet includes a control system for sensing an initial presence of a pet on the stooling floor and for sensing when the pet leaves the stooling floor. The control system is connected to the fluid dispenser and to the drive for initiating dispensing of liquid onto the stooling floor and for initiating the drive to advance the squeegee from the first end of the stooling floor to the second end of the stooling floor and to thereafter return the squeegee to the first end of the stooling floor to complete one cleaning cycle.

### FIELD OF THE INVENTION

The present invention relates to pet toilets, more particularly, the present invention relates to pet toilets which are flushed after use.

### BACKGROUND OF THE INVENTION

Toilets for pets, such as cats and dogs, frequently that take the form of a simple box having an open top. Such toilets are used for paper training young pets and by older pets during inclement whether conditions. Such toilets require substantial maintenance by the pet owners to minimize odors and fly problems. In view of this consideration, attempts have been made to arrange pet toilet systems that are directly connectable to waste disposable systems such as sewers or septic tanks so that the toilets may be flushed and pet waste washed away through suitable drains. It is also desirable that such a flush system operate automatically so there is no need to train the animal to actuate the system and no need for pet owners to monitor the toilet and manually actuate the flush system.

To date, there have been numerous attempts to commercialize such a system, but to the present inventor's knowledge, no such system has achieved wide commercial acceptance. In view of this, Applicant has configured a system which removes pet waste, such as feces and urine, while controlling odors and providing substantial reliability.

### SUMMARY OF THE INVENTION

In view of the aforementioned considerations, a pet toilet comprises a stooling floor for receiving thereon animal waste in the form of feces and urine, the stooling floor having first and second ends. A trough is provided at the second end of the stooling floor for receiving waste from the stooling floor, the trough being connected to a sewer system for disposal of the waste. A squeegee is provided having at least one blade with a first edge in contact with the stooling floor. The blade extends across the stooling floor and is movable from the first end to the second end of the stooling floor to move the waste into the trough. A fluid dispenser for dispensing liquid onto the stooling floor facilitates removal of the waste and washes the floor. The squeegee is advanced from the first end to the second end of the stooling floor to move the waste and liquid toward and into the trough.

In a further aspect of the invention, the toilet includes a control system for sensing an initial presence of a pet on the stooling floor and for sensing when the pet leaves the stooling floor. The control system is connected to the fluid dispenser and to the drive for initiating dispensing of liquid onto the stooling floor and for initiating the drive to advance the squeegee from the first end of the stooling floor to the second end of the stooling floor and to thereafter return the squeegee to the first end of the stooling floor to complete one cleaning cycle.

In a further aspect of the invention the control system further includes a setting control for determining the number of cleaning cycles after use of the toilet by a pet.

In another aspect of the invention, the fluid dispenser is an integral unit with the squeegee and dispenses liquid proximate the squeegee.

In a further aspect of the invention, a source of disinfectant is disposed proximate the end of the stooling floor for disinfecting the squeegee prior to and subsequent to each cleaning cycle.

In still a further aspect of the invention the stooling floor is enclosed within a housing provided with an entry and exit for the pet.

In a further aspect of the invention, the squeegee has a first end and a second end, which ends have wheels which support the squeegee in first and second tracks disposed at first and second sides of the floor, the drive being connected to the squeegee to drive the squeegee along the tracks.

In a further aspect of the invention, the housing includes curtain walls within the housing which isolate the trough and disinfectant station for the squeegee from the stooling floor.

In still another aspect of the invention the pet toilet includes a side drain proximate one side of the stooling floor for draining overflow fluid from the disinfectant pool to the flushing trough.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a front view of a self-cleaning pet toilet configured in accordance with the principles of the present invention;

FIG. 2 is a perspective view of the self-cleaning pet toilet configured in accordance with the principles of the present invention;

FIG. 3 is a top view of the self-cleaning pet toilet of the present invention showing how sidewalls thereof swing out for inspection, cleaning and maintenance of the pet toilet;

FIG. 4A is an elevation taken along lines 4-4 of FIG. 1;

FIG. 4B is an enlarged portion of FIG. 4A;

FIG. 5 is a top view of the cleaning floor taken along lines 5-5 of FIG. 2;

FIG. 6 is a side view of the cleaning floor taken along lines 6-6 of FIG. 2;

FIG. 7 is an enlarged front view of the system of FIG. 6;

FIG. 8 is a side view of a drive system for the squeegee and fluid dispenser of the pet toilet, and

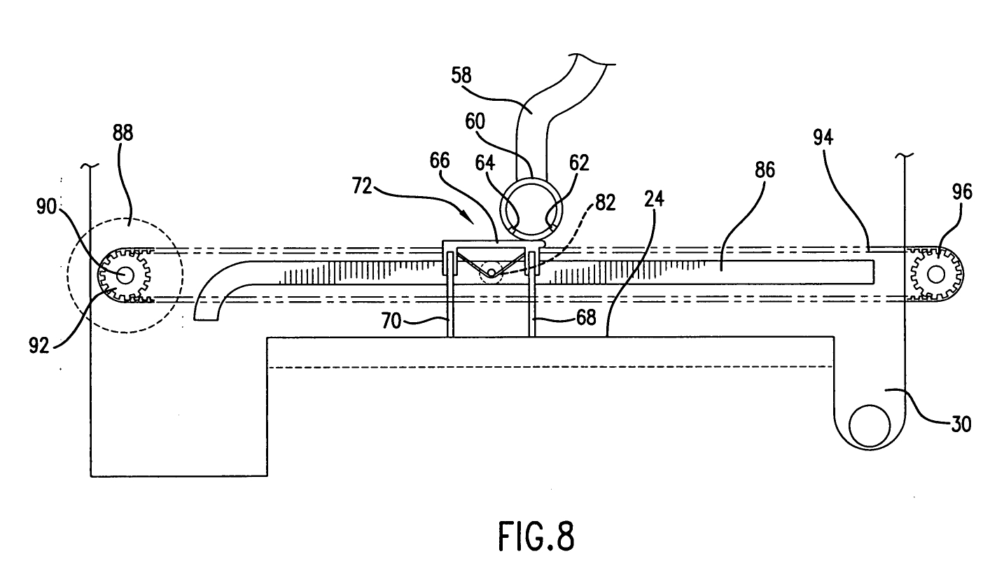

FIG. 9 is a schematic view of a control system for the pet toilet.

### DETAILED DESCRIPTION

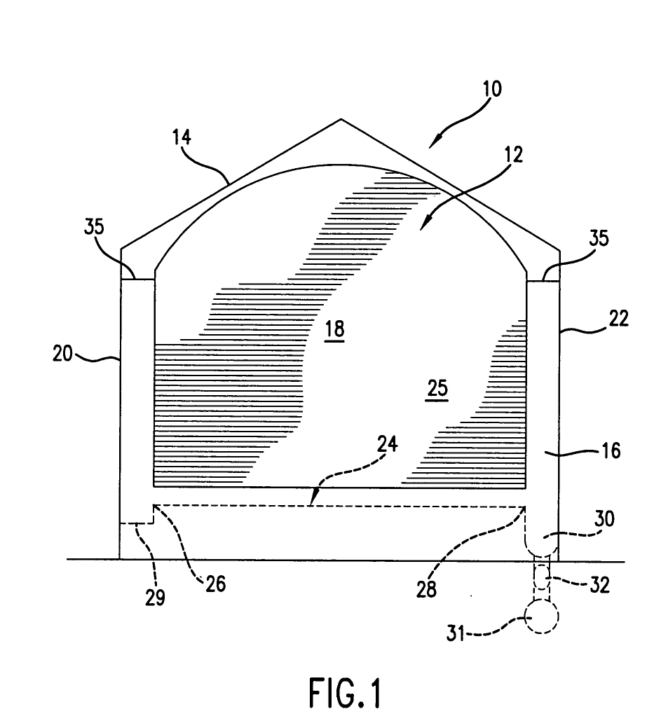

Referring now to FIG. 1 there is shown a self-cleaning pet toilet 10 configured in accordance with the principles of the present invention, wherein the pet toilet has a pet entry 12, a roof 14, a front wall 16 having the entry 12 therethrough, a rear wall 18 and first and second side walls 20 and 22. A stooling floor 24 is disposed in a space 25 defined by the housing 10, the stooling floor having first end 26 and a second end 28. Disposed proximate the first end 26 is a disinfectant pool 29 and disposed proximate the second end of the stooling floor is a flushing trough 30 which is connected to a sewer line 31 via a U-shaped flushing trap 32.

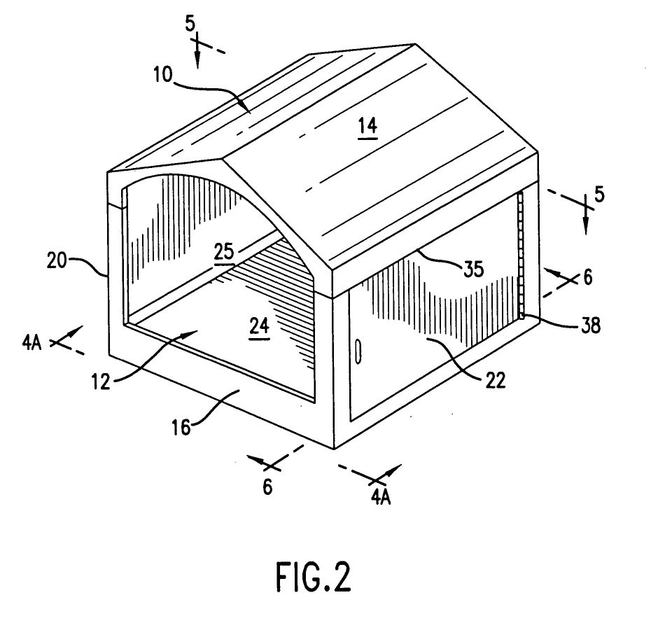

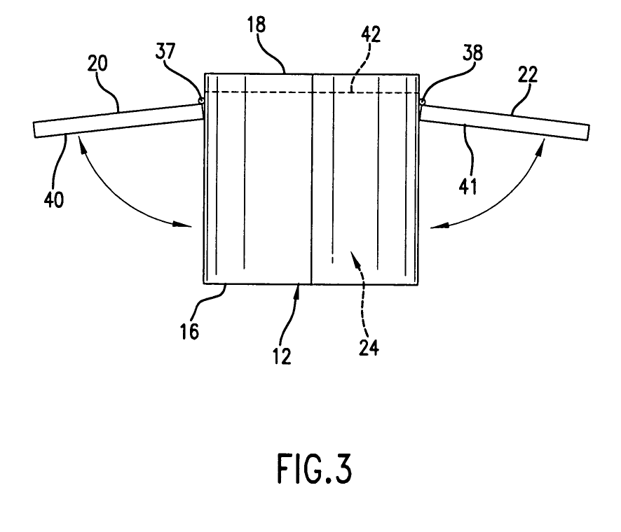

Referring now to FIGS. 2 and 3, it is seen that the roof 14 is removable along a line from the walls of the house to expose the stooling floor 24 from above so that the stooling floor and associated structures are available for inspection, cleaning and maintenance. In addition, the sidewalls 20 and 22 pivot about hinges 37 and 38 to further expose the stooling floor 24. Associated with the sidewalls 20 and 22 are curtain walls 40 and 41 which conceal the disinfectant pool 29 and trough 30 (see FIG. 1) from both view and access by pets using the toilet 10, as well as people in proximity to the toilet 10. In addition, there is a third curtain wall 42 adjacent to the back wall 18 to conceal additional components comprising the pet toilet 10.

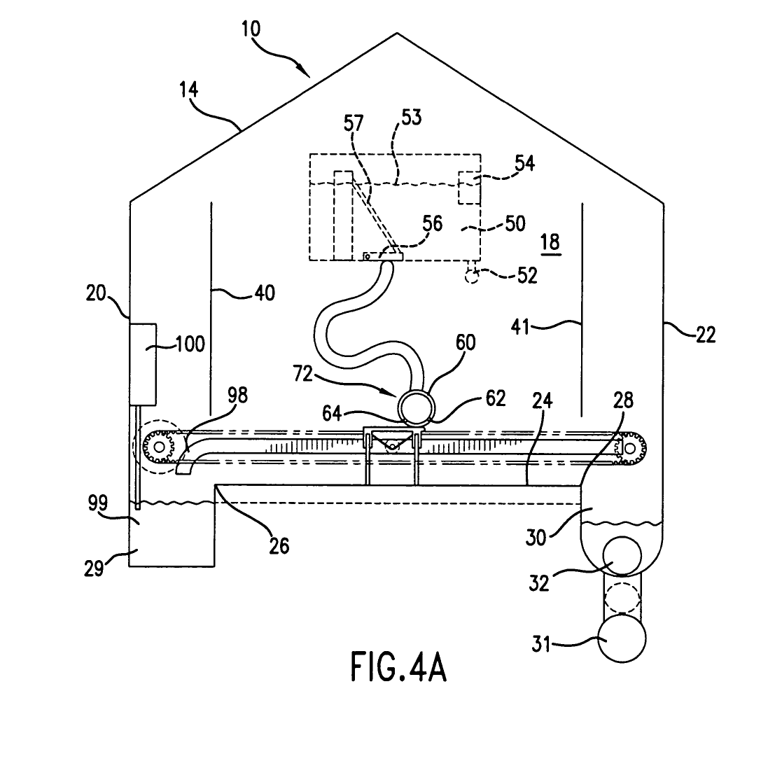

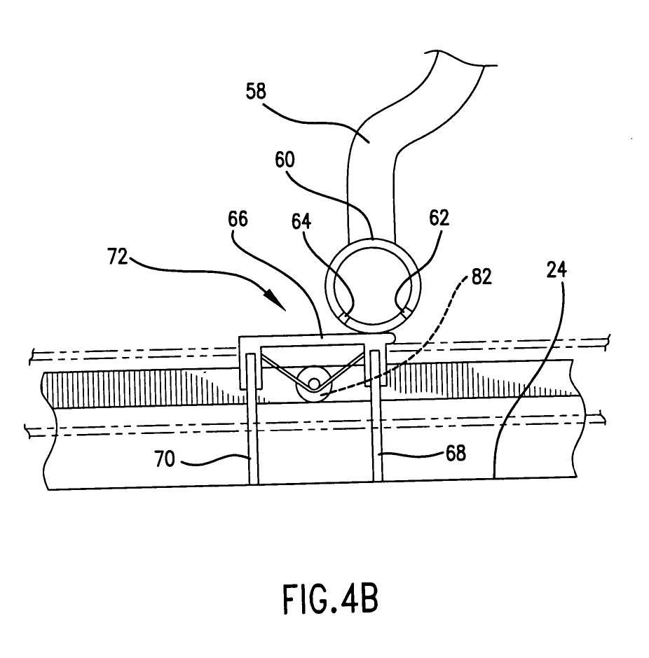

Referring now to FIG. 4 there is shown a water closet 50 which is connected to a tap water line 52 and is filled with water 55 to a height 53 detected by a float switch 54 which turns off inflow through the tap water inlet 52 when the water level reaches a level 53. A valve such as a flapper valve 56 retains the water 55 in the water closet 50 until opened in essentially the same way that a flush tank on a standard toilet retains water in the tank. Upon opening a flush valve 56 with an operator 57, water 55 flows through a flexible water supply line 58 to a horizontal dispensing tube 60. The dispensing tube 60 has perforations 62 and 64 therein that allow the water 55 in the water closet 50 to drain out onto the stooling floor 24. Pet waste on the stooling floor is made more mobile by inundation and undermining with water 55 from the water closet 50. As is best seen in FIG. 4B the perforated tubing 60 is integral with a squeegee clamp 66 that has at least one and preferably two squeegee blades 68 and 70 having edges which engage the stooling floor 24. The tubing 60, squeegee clamp 66 and squeegee blades 68 and 70 form a cleaning assembly 72. The squeegees blade 68 and 70 are preferably of a flexible, resilient, rubber-like material so that when the squeegee clamp 66 and fluid dispensing tube 60 move over the stooling floor 24, the blades 68 and 70 mechanically push and scrape material deposited on the stooling floor toward the flushing trough 30 for disposal through the trap 32 to the sewer connection 31.

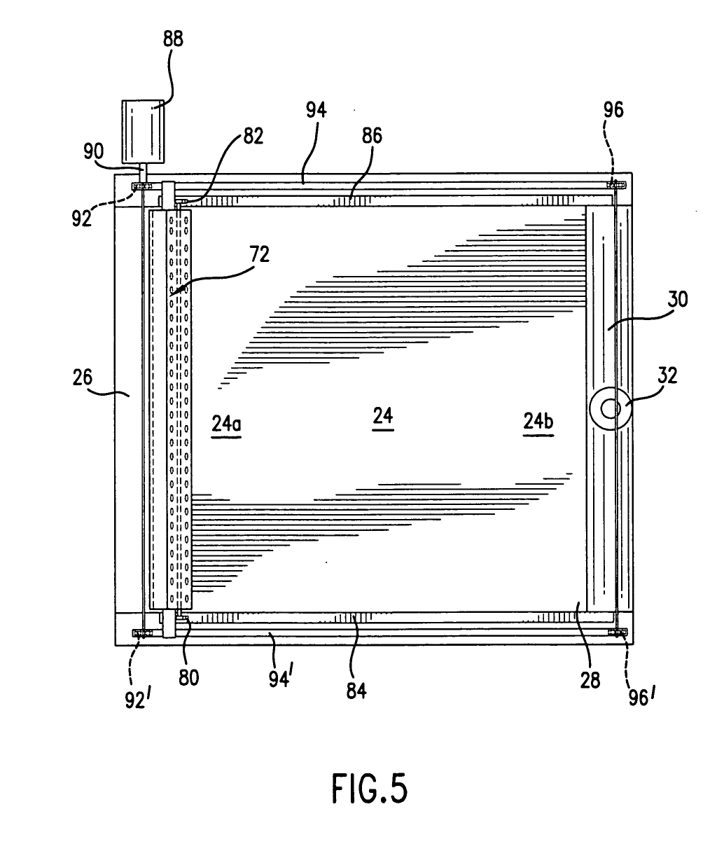

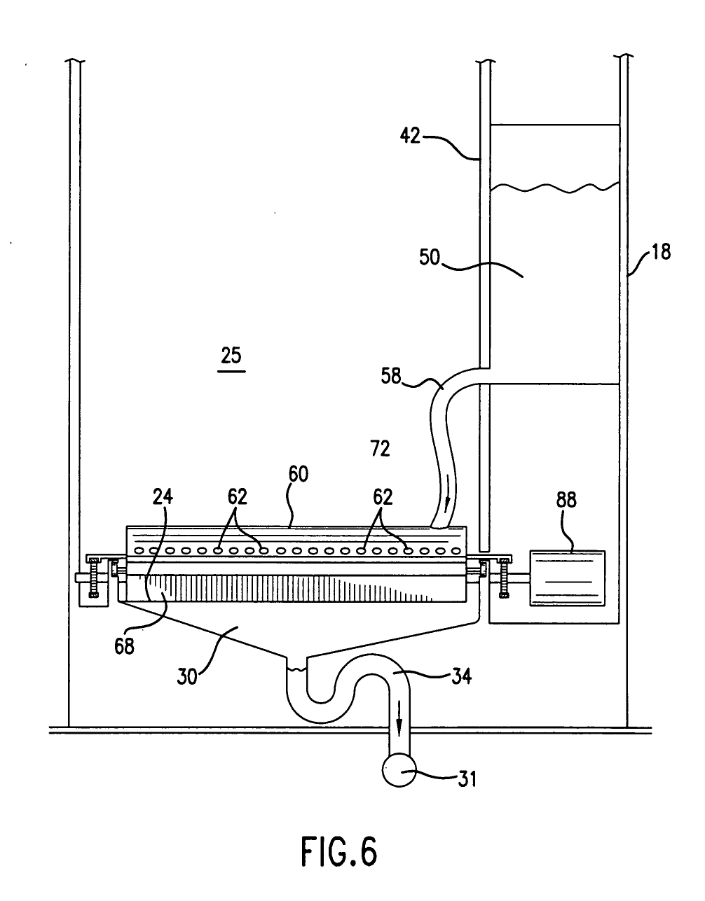

As is best seen in FIG. 5, the cleaning assembly 72 has rollers or wheels 80 and 82 which ride in tracks 84 and 86 as a motor 88 drives the cleaning assembly from the first end 26 toward the second end 28 of the stooling floor 24. As is best seen in FIG. 6, the motor 88 has a drive shaft 90 which is coupled to a first drive sprocket 92 around which is trained an endless belt 94 that loops around an idle sprocket 96. The belt 94 is coupled to the squeegee clamp 66 so as the drive sprocket 92 rotates in the clockwise direction the squeegee clamp advances from the first end 26 to the second end 28 of the stooling floor 24 to push the waste into the flushing trough 30. The motor 92 then reverses direction and rotates counterclockwise to pull the squeegee clamp 66 back toward the first end 26. The water closet 50 may then release additional water 55 and the motor 88 cycles the squeegee clamp 66 back toward the second end of the stooling floor 24 to further clean the stooling floor. This cycle may be repeated two or three times to ensure that the stooling floor 24 is substantially cleaned by the water 55 flowing out of the perforated tubing 60 and the squeegee blades 68 and 67 bearing smoothly against the top surface of the stooling floor 24.

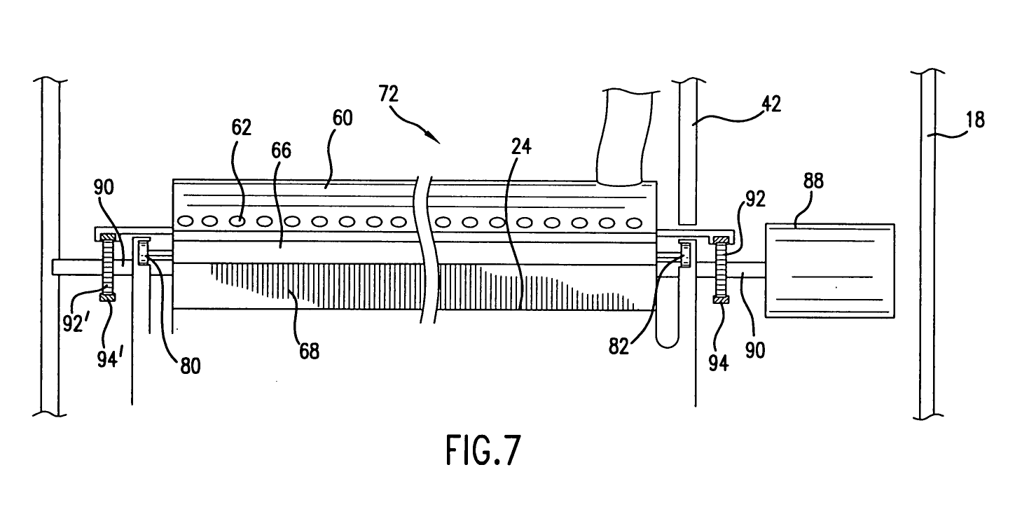

As is seen in FIG. 7, the axle 90 preferably projects across the stooling floor 24 to the other side of the stooling floor, which in this case would be the position adjacent the front wall 16 to rotate a second drive sprocket 92′ similar to the first drive sprocket wheel 92, which second drive sprocket 92′ trains a second endless belt 94′ similar to belt 94 around an idle sprocket wheel 96′ similar to the idle sprocket wheel 96. In this way the cleaning assembly 72 mounted on the squeegee bracket 66 is positively advanced at both ends.

In the illustrated embodiment, there is a leading squeegee blade 67 and a trailing squeegee blade 70. The leading perforations 62 sprays water under pressure in advance of the squeegee blade 68 while the trailing perforations 64 spray fluid in advance of the trailing blade 70. While two blades are shown in a preferred embodiment, the arrangement will function with a single blade.

After the cleaning assembly 72 has washed and scraped the stooling floor 24 it is returned to the pool 29 where the tracks 84 and 86 (FIG. 5) each have a downwardly extending track portion 98. The downwardly extending track portion 98 allows the bracket 66 to dip downwardly toward the pool 29 immersing the blades 68 and 70 in a disinfectant solution 99 in the pool. The pool 29 is periodically recharged with disinfectant 99 from a reservoir 100 that is connected to another switch associated with the pool 29 so that if the level of disinfectant falls below an effective level, disinfectant is discharged from the reservoir into the pool. The pool 29 is connected to a side drain 102 so that excess liquid does not flow onto the stooling floor 24, but drains into the flushing trough 30.

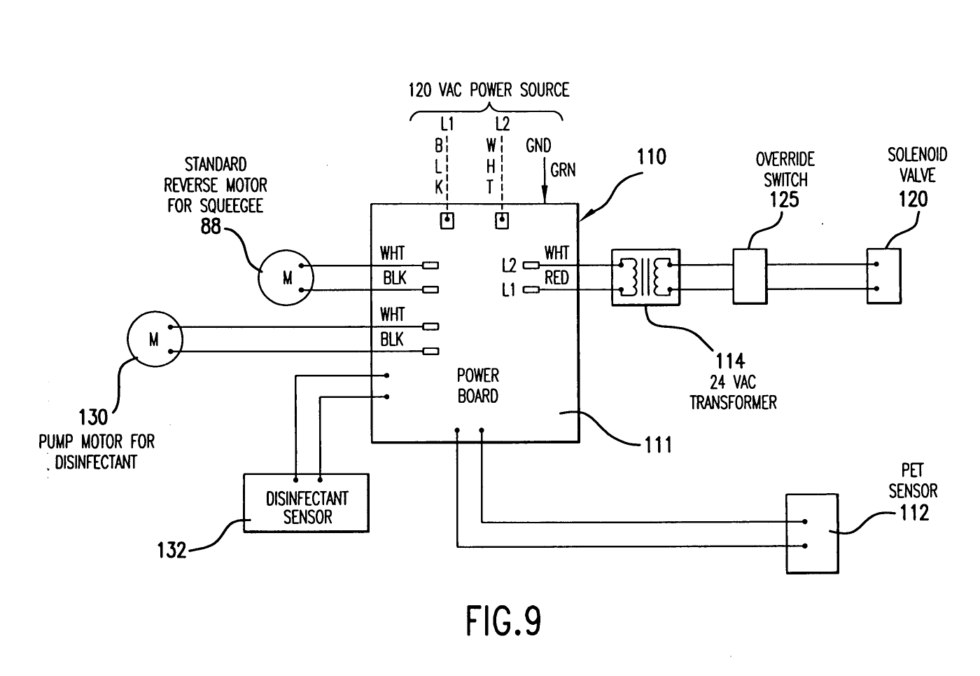

Referring now to FIG. 9, there is shown a control system 110 having a power circuit board 111 which is connected to a proximity sensor 112 that monitors the space 25 within the housing 10 to determine when a pet enters the space and when a pet leaves the space. The proximity switch 112 is connected by a 24 bolt AC transformer 114 via a time delay on the power circuit board to a magnetic solenoid switch 120 which opens the valve 56 in the water closet to allow water to flow through the flexible water supply line 58 to the perforated tube 60. The time delay on the power board circuit 111 is connected to the motor 88 to start rotation of the motor shaft 90 in the clockwise direction in order to move the endless belt 94 to carry the cleaning assembly from it's initial position within the disinfectant pool 29 adjacent the first end 26 of the stooling floor 24 toward the second end 28 of the stooling floor. Upon reaching the second end 28 of the stooling floor 24, a sensor switch detects the cleaning assembly and sends a signal to the motor 88 to reverse direction of the motor so as to carry the cleaning assembly back to the disinfectant pool 29 where still another sensor switch stops rotation of the motor. If necessary or desired this cycle is repeated. An override switch 125 allows one to interrupt operation of the motor 88 and the solenoid valve switch 120. A pump motor 130 pumps the disinfectant 99 into the pool 29 when the control board 111 receives a signal from the disinfectant sensor 132 that the disinfectant has decreased in the pool 29.

From the foregoing description, one skilled in the art can easily ascertain the essential characteristics of this invention, and without departing form the spirit and scope thereof, can make various changes and modifications of the invention to adapt it to various usages and conditions.

We claim:

1. A pet toilet comprising:
a stooling floor for receiving thereon animal waste in the form of feces and urine, the stooling floor having first and second ends;
a trough at the second end for receiving the waste from the stooling floor;
the trough being connected to a sewer system for disposal of the waste;
a squeegee having at least one blade with a first edge in contact with the stooling floor, the blade extending across the stooling floor and being movable from the first end to the second end of the stooling floor to move the waste into the trough;
a fluid dispenser for dispensing liquid onto the stooling floor to facilitate removal of the waste and to wash the floor, and
a drive for moving the squeegee from the first end to the second end of the stooling floor to move the waste and liquid toward and into the trough.

2. The toilet of claim 1 further including a control system, the control having a sensor for sensing an initial presence of a pet on the stooling floor and for sensing when the pet leaves the stooling floor, the control system being connected by a switch arrangement to the fluid dispenser and to the drive for initiating dispensing of liquid onto the stooling floor and for initiating the drive to advance the squeegee from the first end of the stooling floor toward the second end of the stooling floor, the control system including a reversing arrangement connected to the drive to thereafter return the squeegee to the first end of the stooling floor to complete one cleaning cycle.

3. The pet toilet of claim 2 wherein the control system further includes a setting control for determining the number of cleaning cycles between uses of the toilet by a pet.

4. The pet toilet of claim 2 wherein the fluid dispenser is an integral unit with the squeegee and dispenses the liquid proximate the squeegee.

5. The pet toilet of claim 4 wherein the fluid dispenser is perforated tubing connected to a water closet disposed above the perforated tubing to deliver stored water thereto upon being activated by the control system.

6. The pet toilet of claim 5 further including a source of disinfectant proximate the first end of the stooling floor for disinfecting the squeegee prior to and subsequent to each cleaning cycle.

7. The pet toilet of claim 6 wherein the source of disinfectant is a pool in which the blade of the squeegee is immersed, the pool having associated therewith a source for replenishing disinfectant subsequent to each cycle.

8. The pet toilet of claim 7 wherein the stooling floor is enclosed within a housing provided with an entry and exit for the pet.

9. The pet toilet of claim 8 wherein the entry and exit is an opening through a wall of the housing and wherein the housing includes a roof and wall panel which are openable for inspection and maintenance of the pet toilet.

10. The pet toilet of claim 9 wherein the squeegee has a first end and a second end which ends have wheels which support the squeegee in first and second tracts disposed at first and second sides of the floor and wherein the drive means is connected to the squeegee to drive the squeegee along the tracks.

11. The pet toilet of claim 10 wherein the drive comprises a pair of flexible members attached to the squeegee and driven by an electric motor with a reversible output to advance to squeegee toward the tough at the second end of the stooling floor and to return the squeegee to the first end of the stooling floor.

12. The pet toilet of claim 11 further including curtain walls within the housing which isolate the trough and pool from the stooling floor.

13. The pet toilet of claim 12 which further includes a side drain proximate one side of the stooling floor for draining overflow from the disinfectant pool to the flushing trough.

14. The pet toilet of claim 5 wherein the squeegee includes a front and a rear blade and wherein the perforated tube dispenses water from the water closet both in front of the rear blade.

15. The pet toilet of claim 5 wherein the squeegee and perforated tube are integral with a rigid rod which is coextensive therewith and wherein the rigid rod provides an axle for wheels which support the squeegee and fluid dispenser on tracks at the ends of the squeegee, the drive being constructed and arranged to drive the axle along the tracks.

16. The pet toilet of claim 2 further including a source of disinfectant proximate the first end of the stooling floor for disinfecting the squeegee prior to and subsequent to each cleaning cycle.

17. The pet toilet of claim 16 wherein the source of disinfectant is a pool in which the blade of the squeegee is immersed, the pool having associated therewith a source for replenishing disinfectant subsequent to each cycle.

18. The pet toilet of claim 2 wherein the stooling floor is enclosed within a housing provided with an entry and exit for the pet.

19. The pet toilet of claim 1 wherein the fluid dispenser is perforated tubing connected to a water closet disposed above the perforated tubing to deliver stored water thereto upon being activated by the control system.

20. The pet toilet of claim 19 wherein the stooling floor is enclosed within a housing provided with an entry and exit for the pet.
